(19) United States
(12) Patent Application Publication
(10) Pub. No.: US 2020/0350811 A1
(43) Pub. Date: Nov. 5, 2020

(54) MAGNETIC GEAR USING CAN

(71) Applicants: HYUNDAI MOTOR COMPANY, Seoul (KR); KIA MOTORS CORPORATION, Seoul (KR); Industry-University Cooperation Foundation Hanyang University, Seoul (KR)

(72) Inventors: Seung Woo HA, Seoul (KR); Soo Gyung LEE, Seoul (KR); Dong Hee LEE, Seoul (KR); Jae Han SIM, Seoul (KR)

(73) Assignees: HYUNDAI MOTOR COMPANY, Seoul (KR); KIA MOTORS CORPORATION, Seoul (KR); Industry-University Cooperation Foundation Hanyang University, Seoul (KR)

(21) Appl. No.: 16/655,383

(22) Filed: Oct. 17, 2019

(30) Foreign Application Priority Data
May 2, 2019 (KR) 10-2019-0051566

(51) Int. Cl. H02K 49/10

(52) U.S. Cl. CPC H02K 49/102

(57) ABSTRACT

A magnetic gear using a can and the magnetic gear includes: an inner rotor formed with inner spaces where magnets are respectively disposed therein; a guide can surrounding the circumference of the inner rotor; and an outer rotor surrounding the circumference of the guide can. In particular, the guide can is in contact with the inner rotor, thereby securing the rigidity of the inner rotor.

### CROSS-REFERENCE TO RELATED APPLICATION

This application claims priority to and the benefit of Korean Patent Application No. 10-2019-0051566, filed on May 2, 2019, the entire contents of which are incorporated herein by reference.

### FIELD

The present disclosure relates to a magnetic gear having a guide can.

### BACKGROUND

The statements in this section merely provide background information related to the present disclosure and may not constitute prior art.

A magnetic gear is a non-contact-type gear unit that transmits power in a non-contact manner using magnetic force. Compared to a gear that transmits power through a physical contact, the magnetic gear has low noise and vibration, requires no injection of lubricant or maintenance, and has high stability and durability due to the lack of mechanical friction. Thus, studies on the magnetic gear have been actively conducted. Further, since the magnetic gear operates with little energy loss, it is capable of operating with high efficiency and transmitting peak torque reliably and accurately. Thus, in recent years, studies have been conducted with the goal of applying magnetic gears to various industrial fields, such as wind turbines, electric vehicles, and transmissions.

A magnetic gear has a lower torque density than a mechanical gear, and thus it is desired to secure the torque density of the magnetic gear. Examples of magnetic gears include a coaxial type, an axial-gap type, a spur-gear type, and the like. In particular, a coaxial-type magnetic gear is advantageous in providing a relatively high torque density. A coaxial-type magnetic gear is classified into a surface-mounted type, a magnetic-flux-concentrated type, and the like, which have respectively different torque densities. Theoretically, a magnetic-flux-concentrated type is the most advantageous in securing a torque density. However, we have discovered that for convenience of manufacture, a magnetic gear is formed with a lower bridge, and thus causes leakage of magnetic flux.

The above information disclosed in this Background section is only for enhancement of understanding of the background of the disclosure and therefore it may contain information that does not form the prior art that is already known to a person of ordinary skill in the art.

### SUMMARY

The present disclosure provides a magnetic gear capable of securing the rigidity of an inner rotor using a guide can.

The present disclosure provides a magnetic gear using a can, in which permanent magnets are arranged so as to concentrate a magnetic flux.

In one aspect, the present disclosure provides a magnetic gear using a can. The magnetic gear includes: an inner rotor formed with inner spaces where magnets are respectively disposed, a guide can surrounding the circumference of the inner rotor, and an outer rotor surrounding the circumference of the guide can. The guide can is in contact with the inner rotor to secure the rigidity of the inner rotor.

In one form, the inner rotor may define openings connected to the inner spaces, respectively, and each of the openings is extended from the respective inner space along a direction perpendicular to an axial direction of the inner rotor. The guide can may include protruding portions protruding toward the inner rotor, and the openings of the inner rotor respectively receive the protruding portions of the guide can.

In another form, the openings may extend from a front surface of the inner rotor to a rear surface of the inner rotor along the axial direction of the inner rotor, and the front and rear surfaces face to each other.

In still another form, the protruding portions may extend in the axial direction of the inner rotor so as to be inserted into the openings, respectively.

In yet another form, the protruding portions may be provided on the guide can, and may be provided in the same number as the magnets.

In still yet another form, the guide can may be adhered to the inner rotor, and the protruding portions may be inserted into the openings, respectively, and contact a corresponding magnet among the magnets.

In a further form, the guide can may be non-magnetic.

In another further form, each of the magnets may have a magnetization direction that is different from a direction oriented from the inner rotor toward the outer rotor.

In still another further form, each of the magnets may have a magnetization direction that is perpendicular to a diametric direction of the inner rotor.

In yet another further form, the magnets may include a pair of magnets, and the pair of magnets may be arranged adjacent to each other such that magnetization directions thereof are oriented such that magnetic fluxes thereof are concentrated on each other.

In still yet another further form, the magnetic gear may further include a plurality of pole pieces disposed between the guide can and the outer rotor, and the plurality of pole pieces may be disposed so as to be spaced apart from the guide can and the outer rotor.

In a still further form, the magnetic gear may further include a gap defined between each of the plurality of pole pieces and the inner rotor and between each of the pole pieces and the outer rotor in order to concentrate a magnetic flux.

Other aspects and forms of the disclosure are discussed infra.

Further areas of applicability will become apparent from the description provided herein. It should be understood that the description and specific examples are intended for purposes of illustration only and are not intended to limit the scope of the present disclosure.

### DRAWINGS

In order that the disclosure may be well understood, there will now be described various forms thereof, given by way of example, reference being made to the accompanying drawings, in which:

FIG. 1 is a cross-sectional view showing a magnetic gear using a can according to one form of the present disclosure;

FIG. 2 is a view showing the coupling relationship between an inner rotor and a guide can in one form of the present disclosure;

FIG. 3 is a view showing the coupling relationship between an opening and a protruding portion in one form of the present disclosure; and

FIG. 4 is a graph showing the yield strength of the magnetic gear using a can in one form of the present disclosure.

The drawings described herein are for illustration purposes only and are not intended to limit the scope of the present disclosure in any way.

### DETAILED DESCRIPTION

The following description is merely exemplary in nature and is not intended to limit the present disclosure, application, or uses. It should be understood that throughout the drawings, corresponding reference numerals indicate like or corresponding parts and features.

It should be understood that the appended drawings are not necessarily to scale, presenting a somewhat simplified representation of various features illustrative of the basic principles of the disclosure. The specific design features of the present disclosure as disclosed herein, including, for example, specific dimensions, orientations, locations, and shapes, will be determined in part by the particular intended application and use environment.

Advantages and features of the present disclosure and methods for achieving them will be made clear from forms described below in detail with reference to the accompanying drawings. The present disclosure may, however, be embodied in many different forms, and should not be construed as being limited to the forms set forth herein. Rather, these forms are provided so that this disclosure will be thorough and complete, and will fully convey the scope of the disclosure to those skilled in the art.

The terms “part”, “unit”, and “module” described in the specification mean units for processing at least one function or operation, which can be implemented by hardware components, software components, or combinations thereof.

Further, it will be understood that terms such as “first” and “second” are only used to distinguish one element from another element, and the essence, order, or sequence of corresponding elements are not limited by these terms.

The following description is illustrative of the present disclosure. Further, the disclosure is intended to illustrate and explain exemplary forms of the present disclosure, and the present disclosure may be used in various other combinations, modifications, and environments. In other words, the present disclosure may be changed or modified within the scope of the concept of the disclosure disclosed herein, within the equivalent scope of the disclosure, and/or within the skill and knowledge in the art. The described forms illustrate the best state of the art to implement the technical idea of the present disclosure, and various changes may be made thereto as demanded for specific applications and uses of the present disclosure. Accordingly, the following description is not intended to limit the present disclosure to the forms.

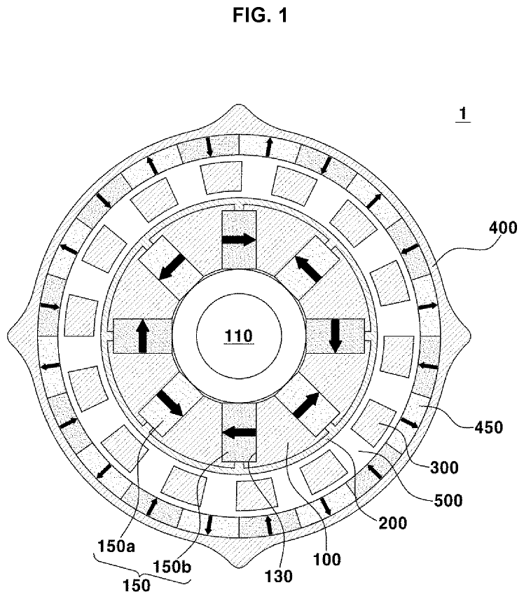

FIG. 1 is a cross-sectional view showing a magnetic gear using a can according to one form of the present disclosure.

Referring to FIG. 1, a magnetic gear 1 may include: an inner rotor 100, a guide can 200, a pole piece 300, and an outer rotor 400. The magnetic gear 1 may be a non-contact-type gear unit that transmits power in a non-contact manner using magnetic force. Compared to a gear that transmits power through physical contact, the magnetic gear 1 has low noise and vibration, requires no injection of lubricant or maintenance, and has high stability and durability due to the lack of mechanical friction.

The inner rotor 100 may signify a structure in which multiple magnetic steel sheets having the same shape are stacked. That is, the inner rotor 100 may be formed of a ferromagnetic material. The inner rotor 100 may have a cylindrical shape. The inner rotor 100 may define a hollow region 110, into which a hollow shaft (not shown) is inserted, and inner spaces 130, into which permanent magnets 150 are inserted. The hollow shaft (not shown), which is press-fitted into the hollow region 110, may be rotated, and the inner rotor 100 may be rotated by the rotation of the hollow shaft (not shown). The inner spaces 130, into which the permanent magnets 150 are inserted, may be provided in a number corresponding to the number of permanent magnets 150. The inner spaces 130 may signify spaces that are formed by penetrating the inner rotor 100. The inner spaces 130 may be arranged in the circumferential direction with respect to the hollow region 110.

The permanent magnets 150 may be arranged in the circumferential direction with respect to the hollow region 110. The permanent magnets 150 may generate a magnetic field. The magnetization direction of each permanent magnet 150 may be perpendicular to the diametric direction of the inner rotor 100. The permanent magnets 150 may be an array of permanent magnets 150a and 150b, which are grouped in pairs, and each pair of permanent magnets 150a and 150b may have different poles from each other. That is, multiple pairs of permanent magnets 150a and 150b may be provided. Each pair of permanent magnets 150a and 150b may be arranged such that the magnetization directions thereof are concentrated on each other. Here, the configuration in which the magnetization directions are concentrated on each other may refer to the configuration in which each pair of permanent magnets 150a and 150b is arranged such that the magnetization directions thereof are not parallel to the direction oriented from the inner rotor 100 toward the outer rotor 400 but are perpendicular to the direction oriented from the inner rotor 100 toward the outer rotor 400. Two adjacent permanent magnets 150, one of which is included in one pair of permanent magnets 150a and 150b and the other one of which is included in another pair of permanent magnets 150a and 150b, may be arranged such that the magnetization directions thereof are not concentrated on each other. The magnetization direction of each permanent magnet 150 may be left or right with respect to the direction oriented from the inner rotor 100 toward the outer rotor 400. The permanent magnets 150 may be arranged such that the magnetization directions of adjacent permanent magnets are opposite each other.

The guide can 200 may be disposed so as to surround the circumference of the inner rotor 100. The guide can 200 may be disposed between the inner rotor 100 and the pole piece 300. The guide can 200 may have a ring shape. The guide can 200 may be formed of a non-magnetic material, and may be formed of a material having high rigidity. For example, the guide can 200 may be formed of a material such as INCONEL 718. The guide can 200 may be adhered to the inner rotor 100 to increase the rigidity of the inner rotor 100. Since the guide can 200, which is a non-magnetic body, surrounds the inner rotor 100 while contacting the permanent magnets 150, the magnetic flux generated in the permanent magnets 150 may be prevented from leaking.

The pole piece 300 may be disposed between the guide can 200 and the outer rotor 400. Here, a plurality of pole pieces 300 may be provided. The pole pieces 300 may be arranged around the inner rotor 100 at regular intervals in the circumferential direction. The number of pole pieces 300 may be determined according to the number of poles of the inner rotor 100 and the outer rotor 400. The pole pieces 300 may generate magnetic field modulation through interaction with the permanent magnets 150 of the inner rotor 100 and magnet groups 450 of the outer rotor 400, thereby serving as a gear that transmits the rotational force of the inner rotor 100 to the outer rotor 400 or transmits the rotational force of the outer rotor 400 to the inner rotor 100. The pole pieces 300 may be disposed so as to be spaced apart from the guide can 200 and the outer rotor 400. A gap 500 may be defined between the pole pieces 300 and the inner rotor 100 and between the pole pieces 300 and the outer rotor 400 in order to concentrate the magnetic flux. The gap 500 may be a space defined by separation between the pole pieces 300 and the guide can 200 and separation between the pole pieces 300 and the outer rotor 400.

The outer rotor 400 may be disposed further outwards than the pole pieces 300 with respect to the inner rotor 100. The outer rotor 400 may include magnet groups 450. The magnet groups 450 may be arranged around the inner rotor 100 in the circumferential direction, and may be attached to the inner surface of the outer rotor 400. The magnet groups 450 may include a first group, the magnetization direction of which is oriented radially inwards, and a second group, the magnetization direction of which is oriented radially outwards. That is, the magnetization direction of the first group may be a direction that is oriented toward the inner rotor 100, and the magnetization direction of the second group may be a direction that is oriented toward the outer rotor 400. The magnet groups 450 may have a structure in which the first group and the second group are alternately arranged.

According to one form of the present disclosure, the permanent magnets 150 may be disposed such that the magnetization directions thereof are concentrated on each other, thus realizing an improvement of the torque density and an increase in the torque density.

Further, in another form of the present disclosure, the magnetic gear 1 including the guide can 200, which is disposed in the gap 500 between the inner rotor 100 and the pole pieces 300, may realize increased output by reducing leakage of magnetic flux compared to a structure in which a lower bridge is applied to a rotor. Furthermore, the guide can 200 serves to reduce or prevent scattering of the magnets, thus improving high-speed rotation and the rigidity of the inner rotor 100.

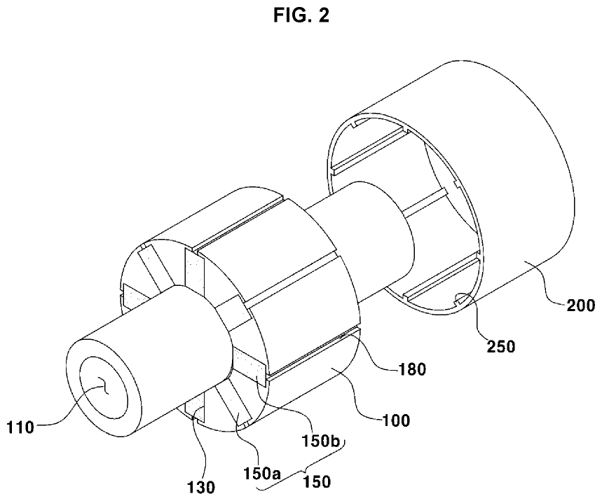

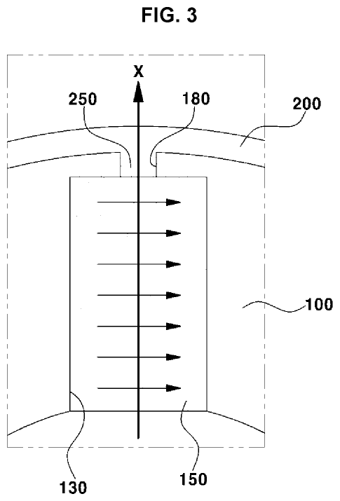

FIG. 2 is a view showing the coupling relationship between the inner rotor and the guide can according to one form of the present disclosure, and FIG. 3 is a view showing the coupling relationship between an opening and a protruding portion according to another form of the present disclosure.

Referring to FIGS. 2 and 3, the guide can 200 may serve to secure the rigidity of the inner rotor 100 through contact with the inner rotor 100 and to guide the attachment position of the inner rotor 100. The guide can 200 may include protruding portions 250, which protrude toward the center of the guide can 200 having a ring shape. The protruding portions 250 may protrude toward the inner rotor 100. The inner rotor 100 may include openings 180 formed therein to open the inner spaces 130 in a first direction x, which is perpendicular to the axial direction. The openings 180 may be defined in the side surface of the inner rotor 100, which has a cylindrical shape. Specifically, the openings 180 may be defined so as to extend from one surface of the inner rotor 100 to the opposite surface of the inner rotor 100 in the axial direction of the inner rotor 100. The one surface of the inner rotor 100 may be a surface that is located at the upper side thereof in the axial direction thereof, and the opposite surface of the inner rotor 100 may be a surface that is located at the lower side thereof in the axial direction thereof. That is, the one surface and the opposite surface of the cylindrical-shaped inner rotor 100 may be surfaces that are oriented in directions opposite each other. The number of openings 180 may be the same as the number of permanent magnets 150, and the number of protruding portions 250 may be the same as the number of openings 180. That is, the protruding portions 250 may extend in the axial direction of the inner rotor 100 so as to correspond to the openings 180. The protruding portions 250 may be inserted into the openings 180 to contact the permanent magnets 150.

According to one form of the present disclosure, the coupling force between the inner rotor 100 and the guide can 200 may be increased due to the insertion of the protruding portions 250 into the openings 180. Thus, the rigidity of the inner rotor 100 may be increased by the guide can 200, and the yield stress during high-speed rotation of the magnetic gear may be increased. Further, the protruding portions 250 may increase the convenience of a process of coupling the guide can 200 to the inner rotor 100.

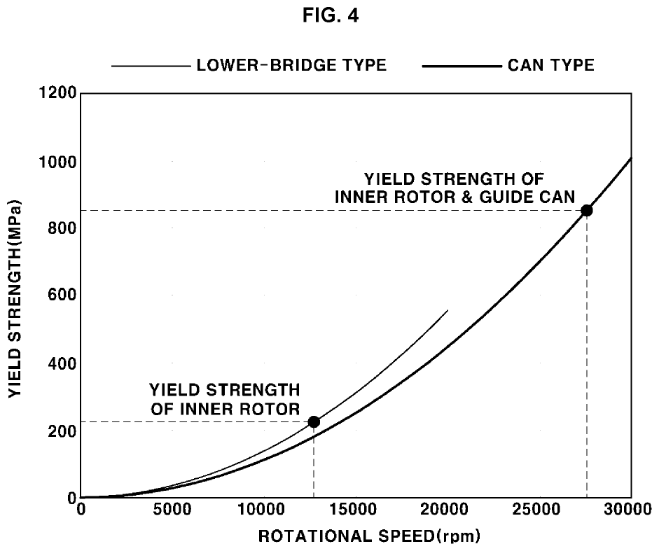

FIG. 4 is a graph showing the yield strength of the magnetic gear using a can according to one form of the present disclosure.

Referring to FIGS. 3 and 4, in general, no separate component is provided between the inner rotor 100 and the pole pieces 300, but only a gap is defined therebetween. A magnetic gear having this configuration may be defined as a lower-bridge type. The lower-bridge-type magnetic gear may be configured such that a bridge-shaped structure is provided between the permanent magnets 150 and the hollow region. In general, a lower-bridge-type structure is applied to a motor. In the magnetic gear according to one form of the present disclosure, the guide can 200 may be disposed between the inner rotor 100 and the pole pieces 300, and a gap (500) may be defined between the guide can 200 and the pole pieces 300. The magnetic gear may be a can type.

In the lower-bridge-type magnetic gear, the bridge structure may be a path along which a magnetic flux leaks. On the other hand, the can-type magnetic gear does not employ a bridge structure, but employs the guide can 200 in order to increase the yield stress when the magnetic gear rotates at a high speed. In the lower-bridge-type magnetic gear, stress is concentrated on the end of the inner rotor 100 when the magnetic gear rotates at a high speed. On the other hand, in the can-type magnetic gear, stress may be dispersed to the end of the inner rotor 100 and to the guide can 200 when the magnetic gear rotates at a high speed. Thus, the can-type magnetic gear may have less leakage of magnetic flux and greater yield strength than the lower-bridge-type magnetic gear.

Referring to the graph in FIG. 4, the inner rotor 100 may be formed of a 50PN470 material, and the guide can 200 may be formed of an INCONEL 718 material. The can-type magnetic gear may rotate at a higher speed than the lower-bridge-type magnetic gear, and may exhibit yield strength that is about four times as high as that of the lower-bridge-type magnetic gear during high-speed rotation thereof. For example, since the guide can 200 is formed of a material having high yield strength, the can-type magnetic gear may rotate up to about 27,000 rpm in the analysis of the rigidity of the inner rotor 100. However, the rotational speed limit of the lower-bridge-type magnetic gear may be 12,000 rpm. Therefore, the magnetic gear is capable of rotating at a higher speed because the yield strength thereof is higher than that of a general magnetic gear and the rigidity of the inner rotor 100 is secured.

As is apparent from the above description, according to the form of the present disclosure, permanent magnets are arranged such that the magnetization directions thereof are oriented such that magnetic fluxes thereof are concentrated on each other, thus realizing improvement of the torque density and an increase in the torque density.

In addition, since a guide can is disposed in a gap between an inner rotor and pole pieces, a magnetic gear according to the form of the present disclosure is capable of realizing increased output by reducing leakage of magnetic flux compared to a structure in which a lower bridge is applied to a rotor. Furthermore, the guide can serves to prevent scattering of the magnets, thus enabling high-speed rotation and securing the rigidity of the inner rotor.

In addition, the magnetic gear according to the form of the present disclosure is capable of inhibiting or preventing leakage of magnetic flux and increasing yield strength during high-speed rotation thereof compared to a general magnetic gear.

It will be appreciated by those skilled in the art that changes may be made in the above exemplary forms without departing from the principles and spirit of the disclosure.

What is claimed is:

1. A magnetic gear, comprising:
an inner rotor formed with inner spaces where magnets are respectively disposed;
a guide can surrounding a circumference of the inner rotor; and
an outer rotor surrounding a circumference of the guide can,
wherein the guide can is in contact with the inner rotor to secure rigidity of the inner rotor.

2. The magnetic gear of claim 1, wherein the inner rotor defines openings connected to the inner spaces, respectively, and each of the openings is extended from the respective inner space along a direction perpendicular to an axial direction of the inner rotor, and
wherein the guide can comprises protruding portions protruding toward the inner rotor, and the openings of the inner rotor respectively receive the protruding portions of the guide can.

3. The magnetic gear of claim 2, wherein the openings extend from a front surface of the inner rotor to a rear surface of the inner rotor along the axial direction of the inner rotor, and the front and rear surfaces face to each other.

4. The magnetic gear of claim 3, wherein the protruding portions extend in the axial direction of the inner rotor so as to be inserted into the openings, respectively.

5. The magnetic gear of claim 2, wherein the protruding portions are provided on the guide can, the protruding portions being provided in a same number as the magnets.

6. The magnetic gear of claim 5, wherein the guide can is adhered to the inner rotor, and
wherein the protruding portions are inserted into the openings, respectively and contact a corresponding magnet among the magnets.

7. The magnetic gear of claim 1, wherein the guide can is non-magnetic.

8. The magnetic gear of claim 1, wherein each of the magnets has a magnetization direction that is different from a direction oriented from the inner rotor toward the outer rotor.

9. The magnetic gear of claim 1, wherein each of the magnets has a magnetization direction that is perpendicular to a diametric direction of the inner rotor.

10. The magnetic gear of claim 1, wherein the magnets comprise a pair of magnets, the pair of magnets being arranged adjacent to each other such that magnetization directions thereof are concentrated on each other.

11. The magnetic gear of claim 1, further comprising a plurality of pole pieces disposed between the guide can and the outer rotor,
wherein the plurality of pole pieces are disposed so as to be spaced apart from the guide can and the outer rotor.

12. The magnetic gear of claim 11, further comprising a gap defined between each of the plurality of pole pieces and the inner rotor and between each of the pole pieces and the outer rotor so as to concentrate a magnetic flux.
